(19) United States
(12) Patent Application Publication
(10) Pub. No.: US 2021/0229118 A1
(43) Pub. Date: Jul. 29, 2021

(54) A CENTRIFUGAL ATOMIZATION STRUCTURE AND A SPRAYING DEVICE WITH THE SAME, A CENTRIFUGAL ATOMIZATION DEVICE, A DRIVE DEVICE AND A DUAL-DRIVE SPRAYING DEVICE

(71) Applicant: Suzhou Eavision Robotic Technologies co., Ltd, Suzhou (CN)

(72) Inventors: Xuesong DONG, Suzhou (CN); Houchen LIU, Suzhou (CN)

(21) Appl. No.: 17/052,184

(22) PCT Filed: May 13, 2019
(86) PCT No.: PCT/CN2019/086703

§ 371 Date: Oct. 31, 2020

(30) Foreign Application Priority Data
May 16, 2018 (CN) 201810468474.7
May 16, 2018 (CN) 201820730631.2
Aug. 29, 2018 (CN) 201810996234.4
Aug. 29, 2018 (CN) 201821399722.9

(51) Int. Cl. B05B 3/10

(52) U.S. Cl. CPC B05B 3/1021; B05B 3/1035

(57) ABSTRACT

A centrifugal atomization structure and a spraying device with the same are provided. The centrifugal atomization structure comprises: a centrifugal atomization disc that is provided with a plurality of flow guide grooves, and each flow guide groove extends from the central position to the edge of the centrifugal atomization disc; an annular body is arranged at the outer side of the centrifugal atomization disc, a plurality of teeth are arranged at intervals along the circumferential direction of the annular body, and the teeth are radially arranged outwards; the annular body and the centrifugal atomization disc are coaxially arranged, and a space is arranged between the annular body and the centrifugal atomization disc in the radial direction; and the center of the centrifugal atomization disc is in transmission connection with an output shaft of a motor to form a spraying device.

### CROSS-REFERENCE TO RELATED APPLICATION

This application claims the priority of Chinese Patent Application No. 201820730631.2, entitled “Centrifugal Atomization Structure and Spraying Device with the Same”, filed in the Chinese Patent Office on May 16, 2018; the priority of Chinese Patent Application No. 201810468474.7, entitled “A Centrifugal Atomization Device”, filed in the Chinese Patent Office on May 16, 2018; the priority of Chinese patent application No. 201821399722.9, entitled “A Drive Device”, filed in the Chinese Patent Office on Aug. 29, 2018; and the priority of Chinese Patent Application No. 201810996234.4, entitled “A Dual-drive Spraying Device”, filed in the Chinese Patent Office on Aug. 29, 2018.

### FIELD

The disclosure relates to the technical field of spraying, in particular to a centrifugal atomization structure, a spraying device with the centrifugal atomization structure, a centrifugal atomization device, a drive device and a dual-drive spraying device.

### BACKGROUND

Atomization refers to the operation of dispersing a liquid into tiny liquid drops through a nozzle or with a high-velocity gas stream. The atomized plurality of dispersed liquid drops can float in the air, so that the contact area with a sprayed object is enlarged, and the spraying effect is improved. Liquid atomization methods include pressure atomization, gas atomization, centrifugal atomization, sonic atomization, etc. The liquid is formed into droplets by a special device and sprayed out in a fog.

The centrifugal force atomization is characterized in that an atomization disc rotates at a high velocity under the action of a motor, and liquid stretches into a thin film on the surface of the rotating atomization disc due to the action of the centrifugal force and moves towards the edge of the disc at a continuously increasing velocity; and when the liquid leaves the edge of the disc, the liquid is atomized into droplets. Due to the design limitation of the existing centrifugal atomization device, the particle diameter of the thrown droplets is not uniform, so that spraying or watering is not uniform, and certain waste is generated to chemical liquid.

### SUMMARY

The present disclosure provides a centrifugal atomization structure and a spraying device with the same, at least enabling atomized particles to be smaller and more uniform.

The disclosure employs a centrifugal atomization structure comprising a centrifugal atomization disc, wherein a plurality of flow guide grooves are formed in the centrifugal atomization disc, and each flow guide groove extends from the central position to the edge of the centrifugal atomization disc. The innovation is as follows.

An annular body is arranged on the outer side of the centrifugal atomization disc, a plurality of teeth are arranged on the annular body at intervals along the circumferential direction of the annular body, and the teeth are radially arranged outwards on the basis of the center of the annular body; and the annular body and the centrifugal atomization disc are coaxially arranged, and a space is arranged between the annular body and the centrifugal atomization disc in the radial direction thereof.

Another disclosure employed in this disclosure is a spraying device which is innovative in that the center of the centrifugal atomization disc in the above disclosure is in transmission connection with an output shaft of a motor.

The relevant content in the above disclosure is explained as follows.

In the above disclosure, a maximum dimension of each tooth in the radial direction of the centrifugal atomization disc is defined as a length of the tooth, a maximum dimension in the direction perpendicular to the radial direction is defined as a width of the tooth, and the length of the tooth is greater than the width of the tooth; and the teeth are spaced and evenly distributed in the circumferential direction of the annular body.

According to the above disclosure, the space between the annular body and the centrifugal atomization disc is 1-20 mm, preferably 1.5-15 mm. If the space is too small, droplets thrown out of the centrifugal atomization disc cannot be completely torn, so that the tearing effect cannot be achieved; and if the space is too large, the droplets lose power, and secondary impact cannot be realized for further atomization.

In the above disclosure, roots of two adjacent teeth are transited in an arc shape to prevent the droplets from accumulating at the roots of the teeth.

According to the above disclosure, chamfers are arranged between the roots of the teeth and the annular body, so that the connection between the teeth and the annular body is more stable.

In the above disclosure, the diameter of the centrifugal atomization disc is 50-400 mm.

According to the above disclosure, the length of the tooth is 2-4 mm. If the length of the tooth is too short, the teeth are designed to be too dense to cause adhesion; and if the length of the tooth is too long, a liquid film is formed on the surface of the tooth when a plurality of droplets simultaneously hit one tooth, so that a next droplet is absorbed by the liquid film, and impact atomization cannot be realized.

In the above disclosure, the circumferential distance between adjacent teeth is greater than or equal to 2 mm, preferably greater than 3 mm, and more preferably greater than 4 mm, to prevent surface tension on the teeth from generating a liquid film and thereby causing the droplets to accumulate on the tooth surfaces.

In the above-mentioned disclosure, the radial cross section of the tooth is of a trapezoid, a rectangle or an angle-rounded structure, preferably a trapezoid, so that the collision with the maximum area is realized, preventing that the droplets cannot pass through the tooth due to the fact that the droplets collide with a short edge of the tooth close to the atomization disc and return; the teeth are provided with rounded corners for easy production and manufacture; and the radial section is a section perpendicular to the axis through a point.

In the above disclosure, the included angle between the radius of the centrifugal atomization disc passing through a middle point of a longest edge of the tooth and the longest edge of the tooth is −7-7°, the included angle between the tangential direction of the curve extension of the flow guide groove and the radius is negative, and the droplets thrown out of the centrifugal atomization disc deviates from the tangent by 15-22° due to centrifugal force and the radian of the flow guide groove. In order to cooperate for that the incidence angles of the droplets impacting on the teeth are about 45°, the angles of the teeth are designed to be −7-7°, preferably 0-7°, more preferably 0°, and the incidence angle is 45°, so that the impact effect of the droplets is improved, and the atomized particles are more uniform.

In the above disclosure, the annular body is externally coated with an electroplated polytetrafluoroethylene layer or a nano layer.

In the above disclosure, the rotation velocity of the centrifugal atomization disc is 2000-50000 rpm, preferably 10000-50000 rpm.

In the above disclosure, the flow guide groove has an Archimedes curve shape.

According to the above-mentioned disclosure, the centrifugal atomization disc is rotationally arranged, the annular body is relatively fixed, or the annular body and the centrifugal atomization disc are oppositely arranged in a rotation direction. When the centrifugal atomization disc and the annular body are reversely arranged in the rotation direction, the relative rotation velocity of the centrifugal atomization disc is improved, and the atomization effect is further improved.

In the above disclosure, the quantity ratio of the teeth to the flow guide grooves is 0.5:1 to 2:1, preferably 1:1 to 1.8:1.

The working principle and advantages of the present disclosure are as follows. According to the disclosure, an annular body is additionally arranged on the periphery of the centrifugal atomization disc, teeth are arranged on the positions of the annular body corresponding to the flow guide grooves. After droplets are thrown out of the centrifugal atomization disc, the droplets impact on the teeth, so that accurate impact and further atomization are realized, and the uniformity of atomized particles is improved. Meanwhile, the average particle diameter of the droplets is reduced by the impact, at least the atomization effect of the average particle diameter of 30 micrometers can be achieved, and even the atomization effect of the average particle diameter of 10 micrometers or less can be achieved. By means of the impact, the atomization is more sufficient, the atomized particles are more uniform, watering and spraying are more uniform for easier penetration, and the use amount of chemical liquid is effectively saved.

The disclosure describes a centrifugal atomization device comprising a centrifugal atomization disc, wherein the centrifugal atomization disc is provided with a plurality of flow guide grooves, and each flow guide groove extends from the central position to the edge of the centrifugal atomization disc; and the innovation is as follows.

An annular body is arranged at the outer side of the centrifugal atomization disc, the annular body and the centrifugal atomization disc are arranged coaxially and able to be rotated relative to each other, and a space is arranged between the annular body and the centrifugal atomization disc in the radial direction; the centrifugal atomization disc rotates to form a positive wind field around the centrifugal atomization disc, and the positive wind field rotates clockwise or counterclockwise around the center of the centrifugal atomization disc; in the working state, the annular body provides a reverse wind field between the annular body and the centrifugal atomization disc, and the rotation direction of the reverse wind field is opposite to that of the positive wind field; the reverse wind field and the positive wind field interact to form an accelerating wind field zone between the centrifugal atomization disc and the annular body; and a plurality of air flow zones are formed on the annular body, the air flow zones are distributed at intervals in the circumferential direction of the annular body, the air flow zones are arranged corresponding to liquid drops thrown out of the flow guide groove, and the air flow direction of the air flow zones is opposite to a running direction of the liquid drops thrown out of the flow guide groove.

The relevant content in the above disclosure is explained as follows.

In the above disclosure, the liquid drops as they are thrown from the edge of the centrifugal atomization disc have a first velocity V1 relative to the static air, the direction of the positive wind field is the same as the rotation direction of the centrifugal atomization disc, and the positive wind field has a second velocity v2 that relatively reduces the relative velocity of the liquid drops and the air, so that the relative velocity of the liquid drops and the air is v1−v2. However, the direction of the reverse wind field is opposite to the direction of the positive wind field and has a third velocity v3; the reverse wind field plays a role in weakening or reversing the positive wind field to greatly increase the relative velocity of the liquid drops and the air, so that the relative velocity of the liquid drops and the air is v1−v2+v3, and the air flow velocity is increased, namely the liquid drop cutting velocity is increased, and the particle diameter of atomized liquid drops is reduced. Meanwhile, the air flow direction of the air flow zone is opposite to the running direction of the liquid drops thrown out of the flow guide groove, so that the cutting of the liquid drops can be better realized, the relative velocity of the liquid drops and the air is improved, and the atomization effect of the liquid drops is improved.

In the above disclosure, the intensity of the reverse wind field is greater than that of the positive wind field, so that the direction of the accelerating wind field zone is the same as that of the reverse wind field. At this point, the realized accelerating wind field zone increases the relative velocity of the liquid drops and the air to a greater extent, doubling the atomization effect. In other cases, the intensity of the reverse wind field can be equal to or smaller than that of the positive wind field. At this point, although the accelerating wind field zone does not realize the reversion in the direction, the positive wind field is still weakened, the relative velocity of the liquid drops and the air is increased, and the atomization effect is still ideal.

In the above disclosure, the space between the annular body and the centrifugal atomization disc in the radial direction thereof is 1-20 mm. If the space is too small, the accelerating wind field zone cannot be provided; and if the space is too large, the accelerating wind field zone has no effect.

According to the above disclosure, the annular body is relatively fixed, a circle of air guide grooves are formed in the annular body along the circumferential direction of the annular body, a plurality of air holes are formed in the inner circumferential surface of the annular body, the air holes are communicated with the air guide grooves and distributed at intervals in the circumferential direction of the annular body, and the air flow zone is led out of the air guide grooves along the extending direction of the air holes.

Preferably, the gas holes are spaced and evenly distributed in the circumferential direction of the annular body.

Preferably, the air guide groove is in communication with an air outlet of an air pump.

Preferably, an included angle between the axis of the air hole and the radius of the centrifugal atomization disc passing through the projection line center of an air hole wall of the axial section thereof is 60-75° on the axial section of the air hole perpendicular to the axis of the centrifugal atomization disc.

Preferably, the hole diameter of the air outlet of the air hole is 1-3 mm.

Preferably, the quantity ratio of the air holes to the flow guide grooves is 1:1 to 2:1.

Preferably, the annular body is coated with an electroplated polytetrafluoroethylene layer or a nano layer, so that the annular body has a non-sticking effect to prevent liquid drop accumulation and improve the atomization effect.

According to the above disclosure, the annular body reversely rotates relative to the centrifugal atomization disc, a plurality of teeth are arranged on the annular body at intervals along the circumferential direction of the annular body, the teeth are radially arranged outwards on the basis of the center of the annular body, and the air flow zone is generated at one side, close to the centrifugal atomization disc, of the teeth.

Preferably, the radial section of the tooth is rectangular or arc-shaped;

When the radial section of the tooth is rectangular, the included angle between the radius of the centrifugal atomization disc passing through a middle point of a long side of the rectangle and the long side is 0-60°;

When the radial section of the tooth is arc-shaped, the included angle between the radius of the centrifugal atomization disc passing through the middle point of the arc shape and a tangent line passing through the middle point of the arc shape is 0-60°.

Preferably, the circumferential distance between two adjacent teeth is greater than 2 mm, preferably greater than 3 mm, more preferably greater than 4 mm, to prevent surface tension on the teeth from generating a liquid film and thereby causing the droplets to accumulate on the tooth surfaces.

Preferably, the tooth has a dimension of 2-4 mm in the radial direction, a dimension of greater than 3 mm in the axial direction, and a dimension of 0.5-1 mm perpendicular to the radial direction. If the dimension of the tooth in the radiation direction is too short, the teeth are designed to be too dense to cause adhesion; and if the dimension of the tooth in the radiation direction is too long, a liquid film is formed on the surface of the tooth when a plurality of liquid drops simultaneously hit one tooth, so that a next liquid drop is absorbed by the liquid film, and secondary impact atomization cannot be realized. When the radial section of the tooth is arc-shaped, the chord length corresponding to the arc is the dimension of the tooth in the radial direction thereof.

Preferably, the space between the annular body and the centrifugal atomization disc in the radial direction thereof is 1-20 mm, preferably 3-10 mm. If the space is too small, an accelerating wind field zone cannot be provided. If the space is too large, the accelerating wind field zone has no effect, the accelerating wind field zone cannot achieve its effect of increasing the relative velocity of the liquid drops, and at the same time, further impact effect cannot be achieved. Preferably, the teeth are spaced and evenly distributed in the circumferential direction of the annular body.

Preferably, the annular body and the teeth are coated with an electroplated polytetrafluoroethylene layer or a nano layer, so that the annular body and the teeth have a non-sticking effect to prevent liquid drop accumulation and improve the atomization effect.

Preferably, the rotation velocity of the centrifugal atomization disc is 2000-50000 rpm, preferably 10000-50000 rpm; and the rotation velocity of the annular body is 2000-50000 rpm, preferably 10000-50000 rpm.

Preferably, the quantity ratio of the teeth to the flow guide grooves is 0.5:1 to 2:1, preferably 1:1 to 1.8:1.

In the above disclosure, the diameter of the centrifugal atomization disc is 50-300 mm.

In the above disclosure, the flow guide groove has an Archimedes curve shape.

The working principle and advantages of the present disclosure are as follows. According to the disclosure, an annular body is additionally arranged on the periphery of the centrifugal atomization disc, and the annular body and the centrifugal atomization disc are arranged coaxially and able to be rotated relative to each other. in the working state, the wind field generated by the annular body is opposite in the direction to the wind field generated by the centrifugal atomization disc. Although the wind field generated by the centrifugal atomization disc still exists, the wind field generated by the centrifugal atomization disc is weakened or reversed by the wind field generated by the annular body, and the formed accelerating wind field zone greatly improves the relative rotation velocity of the centrifugal atomization disc and the air airflow; and the relative velocity of liquid drops relative to the air can be improved without increasing the rotation velocity of the atomization disc, so that the average particle diameter of the liquid drops is reduced, the atomization is more sufficient, the atomized particles are more uniform, watering and spraying are more uniform for easier penetration, and meanwhile, the use amount of the chemical liquid is effectively saved.

The disclosure also provides a drive device which is stable in structure, not easy to cause friction and small in moment of inertia so as to realize rotation control at a high rotation velocity. Specifically, the disclosure can comprise: a first drive motor including a first output shaft extending out of the body of the first drive motor by a preset length; a second drive motor including a hollow second output shaft, wherein the first drive motor is arranged coaxially and in series with the second drive motor, and the first output shaft penetrates through the second output shaft and extends out of the second output shaft; and a connecting piece and a holder coaxially arranged at a tail end of the second output shaft, wherein one end of the connecting piece is sleeved on and fixed with the connecting piece, and the other end of the connecting piece is filled with a holder sleeved on the first output shaft.

Preferably, the holder includes an inner ring fixedly connected with the first output shaft, an outer ring fixedly connected with the connecting piece, and a rolling body arranged between the inner ring and the outer ring to generate rolling friction.

Preferably, the first output shaft and the second output shaft cooperate to have a radial clearance ≥0.1 mm and/or ≤1 mm.

Preferably, the first drive motor comprises a first rotor arranged on an inner race to drive the first output shaft to rotate and a first stator arranged on an outer race, the second drive motor comprises a second rotor arranged on an inner race to drive the second output shaft to rotate and a second stator arranged on an outer race, and the first stator and the second stator are respectively fixedly connected with a housing sleeved outside the first drive motor and the second drive motor.

The main purpose of the present disclosure includes providing a dual-drive spraying device with small moment of inertia, stable structure and high rotation velocity to improve the spraying atomization effect and the operation efficiency.

In order to achieve the above object, a dual-drive spraying device is provided, comprising a first drive motor including a first output shaft extending out of the body of the first drive motor by a preset length; a second drive motor arranged coaxially and in series with the first drive motor and comprising a hollow second output shaft, wherein the first output shaft penetrates through the second output shaft and extends out of the second output shaft; a first rotary disc sleeved on and fixedly connected with the first output shaft; a second rotary disc sleeved on and fixedly connected with the second output shaft; and a connecting piece and a holder coaxially arranged at a tail end of the second output shaft, wherein one end of the connecting piece is sleeved on and fixed with the connecting piece, and the other end of the connecting piece is filled with a holder sleeved on the first output shaft.

Preferably, the second rotary disc is sleeved on the connecting piece and fixedly connected with the second output shaft.

Preferably, the connecting piece comprises a hollow raised mating portion, the mating portion forms a filling cavity to fill the holder, and the second rotary disc is sleeved on the mating portion.

Preferably, the mating portion is circumferentially provided with a flange.

Preferably, the first rotary disc is sleeved at a tail end of the first output shaft, and the second rotary disc has an axial space from the first rotary disc in the axial direction.

Preferably, a radial side of the first rotary disc is circumferentially provided with a plurality of teeth having a radial space from an axial side of the second rotary disc.

Preferably, the diameter of the first output shaft is ≤8 mm, the hollow diameter of the second output shaft is ≤12 mm, and the radial width of the side wall of the second output shaft 21 is ≤5 mm.

According to the technical solution disclosed by the disclosure, the two drive motors are arranged in series, so that the rotation of the first rotary disc and the second rotary disc is controlled, the diameters of the first output shaft and the second output shaft are reduced, and the moment of inertia is reduced; at the same time, the first output shaft and the second output shaft are supported by the arrangement of the connecting piece and the holder, so as to avoid friction between the two, increase the stability of the spraying device, make it realize the spraying control with high rotation velocity and high stability, and improve the spraying atomization effect and the working efficiency.

### BRIEF DESCRIPTION OF THE DRAWINGS

FIG. 1 is a front view of a centrifugal atomization structure provided by an embodiment of the present disclosure;

FIG. 2 is a perspective view of a centrifugal atomization structure provided by an embodiment of the present disclosure;

FIG. 3 is another perspective view of a centrifugal atomization structure provided by an embodiment of the present disclosure;

FIG. 4 is yet another perspective view of a centrifugal atomization structure provided by an embodiment of the present disclosure;

FIG. 5 is another front view of a centrifugal atomization structure provided by an embodiment of the present disclosure;

FIG. 6 is an enlarged partial view of FIG. 5;

FIG. 7 is a front view of a centrifugal atomization device provided by an embodiment of the present disclosure;

FIG. 8 is a perspective view of the centrifugal atomization device provided by the embodiment of FIG. 7;

FIG. 9 is another perspective view of a centrifugal atomization device provided by an embodiment of the present disclosure;

FIG. 10 is a schematic cross-sectional view of a drive device according to an alternative embodiment of the present disclosure;

FIG. 11 is a schematic cross-sectional view of a drive device according to another alternative embodiment of the present disclosure;

FIG. 12 is an enlarged partial view of part A of FIG. 11;

FIG. 13 shows a schematic cross-sectional view of a drive device according to yet another alternative embodiment of the present disclosure;

FIG. 14 is a structurally schematic view of a connecting piece of a drive device according to an alternative embodiment of the present disclosure;

FIG. 15 is a schematic cross-sectional view of a dual-drive spraying device according to an alternative embodiment of the present disclosure;

FIG. 16 is an enlarged partial view of part A of FIG. 15;

FIG. 17 is a schematic cross-sectional view of a dual-drive spraying device according to another alternative embodiment of the present disclosure;

FIG. 18 is a structurally schematic view of a dual-drive spraying device according to yet another alternative embodiment of the present disclosure; and

FIG. 19 shows a structurally schematic view of a connecting piece of a dual-drive spraying device according to an alternative embodiment of the present disclosure.

List of reference numerals in the drawings:
1 centrifugal atomization disc;
11 flow guide groove;
2 annular body;
21 tooth;
23 air hole;
3 space;
100 drive device;
10 first drive motor;
101 first output shaft;
12 first stator;
13 first rotor;
14 first rotary disc;
141 first positioning hole;
142 tooth;
20 second drive motor;
201 second output shaft;
202 second stator;
203 second rotor;
24 second rotary disc;
241 second positioning hole;
242 flow channel;
30 housing;
4 connecting piece;
41 mating portion;
42 filling cavity;
43 flange;
5 holder;
51 inner ring;
52 outer ring;
53 rolling body;
54 retainer;
6 bearing;
7 shaft sleeve;
8 seal;
200 dual-drive spraying device.

### DESCRIPTION

In order to make the objectives, technical solutions and advantages of the embodiments of the present disclosure clearer, the technical solutions in the embodiments of the present disclosure will be described clearly and completely in conjunction with the accompanying drawings in the embodiments of the present disclosure. Obviously, the described embodiments are part of the embodiments of the present disclosure, rather than all of the embodiments. Based on the embodiments in this disclosure, all other embodiments obtained by one of ordinary skill in the art without involving any inventive effort are within the scope of this disclosure.

The present disclosure is further described below with reference to the accompanying drawings and embodiments.

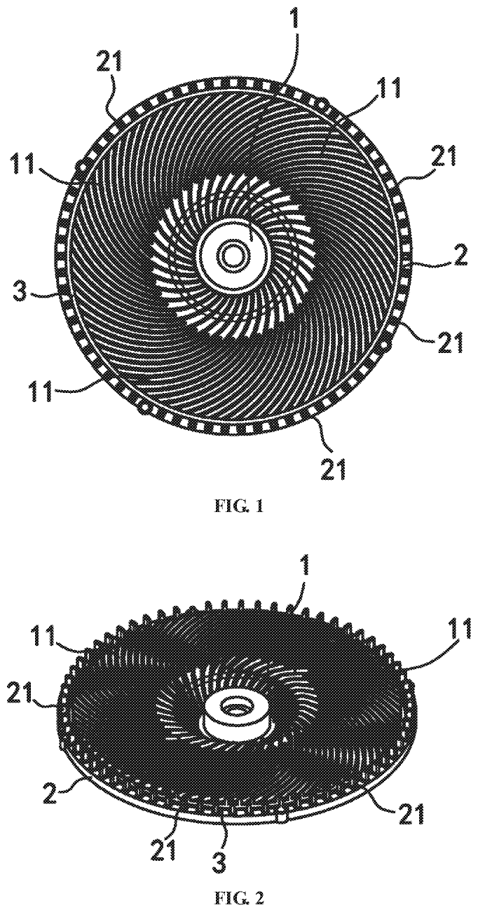

As shown in FIGS. 1 and 2, a centrifugal atomization structure comprises a centrifugal atomization disc 1, wherein a plurality of flow guide grooves 11 are formed in the centrifugal atomization disc 1, each flow guide groove 11 extends from the central position to the edge of the centrifugal atomization disc 1, and an outlet of each flow guide groove 11 is opened at the edge of the centrifugal atomization disc 1.

An annular body 2 is arranged outside the centrifugal atomization disc 1, the annular body 2 and the centrifugal atomization disc 1 are coaxially arranged, and a space 3 is arranged between the annular body 2 and the centrifugal atomization disc 1 in the radial direction thereof. A plurality of teeth 21 are uniformly arranged on the annular body 2 at intervals along the circumferential direction of the annular body 2, the teeth 21 are arranged corresponding to the flow guide grooves 11, and the teeth are radially arranged outwards on the basis of the center of the annular body, which is purposed for that long sides of two adjacent teeth 21 are oppositely arranged, and the droplets can impact on the teeth 21 after being thrown out of the centrifugal atomization disc 1, so that accurate atomization is realized.

The space 3 may be 2 mm. If the space 3 is too small, the droplets thrown out of the centrifugal atomization disc 1 cannot be completely torn, so that the tearing effect cannot be achieved; and if the space 3 is too large, the droplets lose power, and the impact cannot be realized for further atomization.

The length of the tooth 21 may be 3 mm. If the length of the tooth 21 is too short, the teeth 21 are designed to be too dense to cause adhesion; and if the length of the tooth 21 is too long, a liquid film is formed on the surface of the tooth 21 when a plurality of droplets simultaneously hit one tooth 21, so that a next droplet is absorbed by the liquid film, and impact atomization cannot be realized.

The circumferential distance between adjacent teeth 21 may be greater than 4 mm to prevent surface tension on the teeth 21 from generating a liquid film and thereby causing the droplets to accumulate on the surfaces of the teeth 21.

The radial cross section of the tooth 21 has a rectangular structure. The diameter of the centrifugal atomization disc may be 200 mm. The rotation velocity of the centrifugal atomization disc may be 20000 rpm.

In order to cooperate for that the incidence angles of the droplets impacting on the teeth 21 are about 45°, the angles of the teeth 21 are designed to be preferably 0°, and the incidence angle may be 45°, so that the impact effect of the droplets is improved, and the atomized particles are more uniform.

Chamfers are arranged between the roots of the teeth 21 and the annular body 2, so that the connection between the tooth 21 and the annular body 2 is more stable.

The annular body 2 is externally coated with an electroplated polytetrafluoroethylene layer or a nano layer, so that the non-stick effect is realized, and the droplets are prevented from accumulating on the surface of the annular body.

The flow guide groove 11 has an Archimedes curve shape, so that the centrifugal atomization effect is improved.

The quantity ratio of the teeth to the flow guide grooves may be 0.5:1 to 2:1, and optionally, the teeth 21 and the flow guide grooves 11 are arranged in a ratio of 0.8:1 or 1.5:1, so long as the droplets thrown out of each flow guide groove 11 can impact between two adjacent teeth 21.

When the centrifugal atomization disc 1 rotates around the axis thereof, the annular body 2 is fixed relative to the axis thereof, or the annular body 2 and the centrifugal atomization disc 1 are oppositely arranged in the rotation direction. At the moment, the rotation direction of the annular body 2 is opposite to that of the centrifugal atomization disc 1; and when the centrifugal atomization disc 1 and the annular body 2 are reversely arranged in a turning direction, the air flow velocity is improved, which is equivalent to that the relative rotation velocity of the centrifugal atomization disc 1 is increased, and the atomization effect is further improved.

According to the disclosure, an annular body 2 is additionally arranged on the periphery of the centrifugal atomization disc 1, teeth 21 are arranged on the positions of the annular body 2 corresponding to the flow guide grooves 11, and droplets impact the teeth 21 after being thrown out of the centrifugal atomization disc 1. By the teeth 21 on the ring body 2 carefully designed by a structural design of the disclosure, it is ensured that the droplets coming out of the centrifugal atomization disc 1 can more effectively impact between two adjacent teeth 21; on the one hand, the impact angle is better; and on the other hand, the number design of the teeth 21 and the flow guide grooves 11, and the dimension design of the teeth 21 prevent the droplets from accumulating on the teeth 21 due to generation of liquid films and the like, so that better atomization effect can be achieved, and the uniformity of atomized particles is improved; meanwhile, the average particle diameter of the droplets is reduced by the impact, achieving the atomization effect of the average particle diameter of 30 micrometers, and even the atomization effect of the average particle diameter of 10 micrometers or below; and the watering and spraying is more uniform for easier penetration, and meanwhile, the use amount of the chemical liquid is effectively saved.

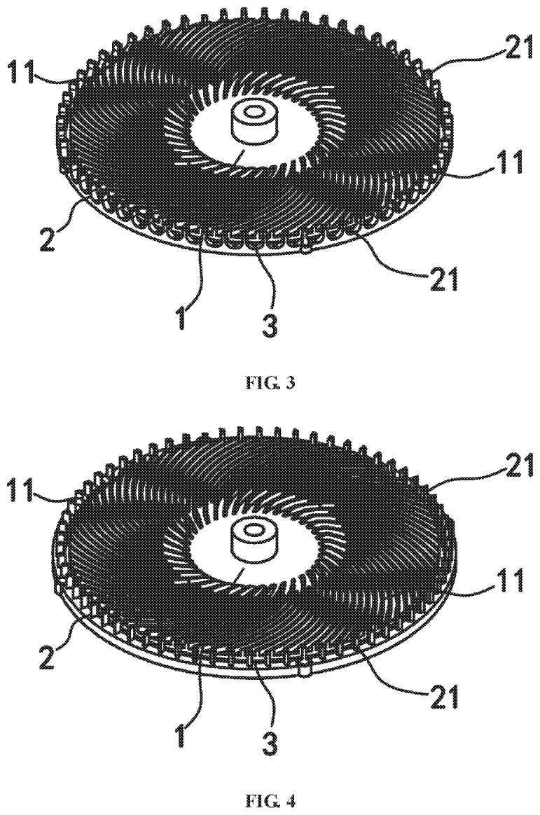

Referring to FIG. 3, the roots of two adjacent teeth 21 are transited in an arc shape to prevent droplets from accumulating at the roots of the teeth, and the rest are the same as those of the above-described embodiment and will not be described in detail.

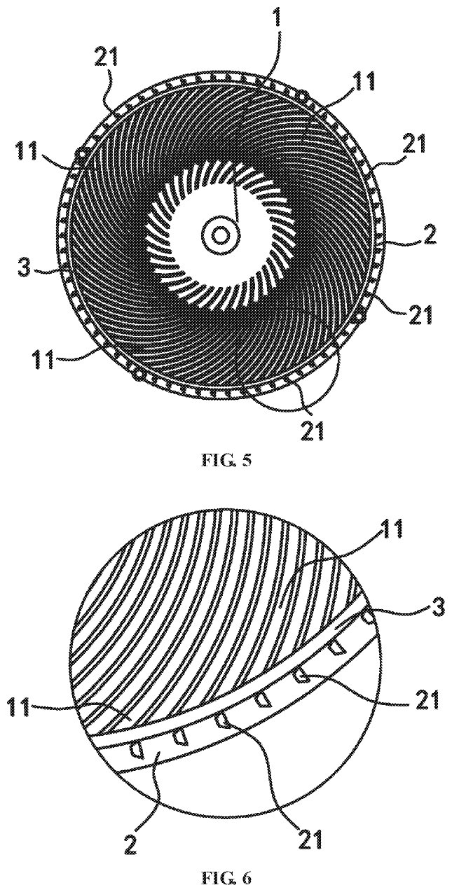

Referring to FIGS. 4-6, the teeth 21 are trapezoidal in radial cross-section to achieve maximum area impingement to prevent droplets from returning due to impingement on the short side, and the rest is the same as in the embodiments described above and not further described herein.

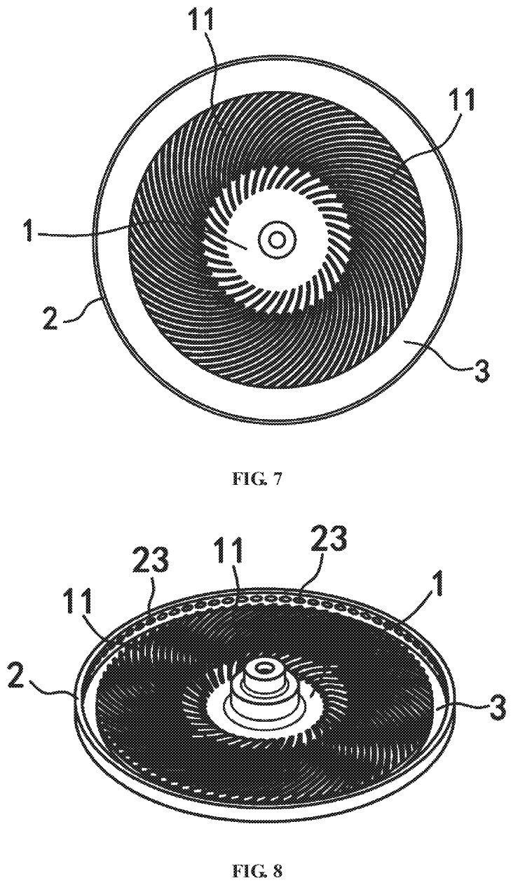

For a brief description, reference is made to the above-described embodiments if there is anything not mentioned in this embodiment. Further preferably, referring to FIGS. 7 and 8, the centrifugal atomization device provided by the embodiment comprises the centrifugal atomization structure described in the embodiment, and the technical solution described in the embodiment also belongs to the embodiment. In addition, the centrifugal atomization disc 1 described in the above embodiment also belongs to the centrifugal atomization disc 1 provided in the present embodiment.

According to one embodiment of the disclosure, there is provided a centrifugal atomization device arranged on a spraying apparatus (a handheld spraying apparatus or spraying unmanned aerial vehicle and the like) (not shown), wherein the centrifugal atomization device comprises a centrifugal atomization disc 1, a plurality of flow guide grooves 11 are formed in the centrifugal atomization disc 1, and each flow guide groove 11 extends from the central position to the edge of the centrifugal atomization disc 1.

An annular body 2 is arranged at the outer side of the centrifugal atomization disc 1, and the annular body 2 and the centrifugal atomization disc 1 are arranged coaxially and able to be rotated relative to each other, wherein the centrifugal atomization disc 1 is rotationally arranged relative to the main body of the spraying apparatus, the centrifugal atomization disc 1 is driven to rotate by a motor, the annular body 2 is fixedly arranged relative to the main body of the spraying apparatus, and a space 3 is arranged between the annular body 2 and the centrifugal atomization disc 1 in the radial direction thereof.

A circle of air guide grooves are formed in the annular body 2 along the circumferential direction of the annular body 2, a plurality of air holes 23 are formed in the inner circumferential surface of the annular body 2, the air holes 23 are communicated with the air guide grooves, the air holes 23 are uniformly distributed at intervals in the circumferential direction of the annular body 2, and the air flow direction of an air outlet of the air hole 23 is opposite to a running direction of liquid drops thrown out of the flow guide grooves 11 in the centrifugal atomization disc 1. Therefore, a wind field opposite to the centrifugal atomization disc 1 is generated on the periphery of the centrifugal atomization disc 1 to improve the relative rotation velocity of the centrifugal atomization disc 1 relative to the air flow.

The liquid drops thrown from the edge of the centrifugal atomization disc 1 have a first velocity v1 relative to the static air, the direction of the positive wind field is the same as the rotation direction of the centrifugal atomization disc 1, and the positive wind field has a second velocity v2 that relatively reduces the relative velocity of the liquid drops and the air, so that the relative velocity of the liquid drops and the air is v1−v2. However, the direction of the reverse wind field is opposite to the direction of the positive wind field and has a third velocity v3, greatly increasing the relative velocity of the liquid drops and the air, so that the relative velocity of the liquid drops and the air is v1−v2+v3; and the reverse wind field plays a role in weakening or reversing the positive wind field, the air flow velocity is increased, namely the liquid drop cutting velocity is increased, and the particle diameter of atomized liquid drops is reduced. The relative velocity of the liquid drops and the air is increased, i.e. indirectly equal to that the relative rotation velocity of the centrifugal atomization disc and the air is increased. By using the centrifugal atomization device provided by the embodiment of the disclosure, the particle diameter of liquid drops of 1-30 micrometers can be realized, and the average particle diameter thereof can reach about 10 micrometers, the average particle diameter of the liquid drops is effectively reduced, and the atomization effect is greatly improved. Meanwhile, the air flow direction of the air flow zone is opposite to the running direction of the liquid drops thrown out of the flow guide groove, so that the cutting of the liquid drops can be better realized, the relative velocity of the liquid drops and the air is improved, and the atomization effect of the liquid drops is improved. Here the gas flow direction of the gas flow zone is opposite to the running direction of the liquid drops. It can be understood that the angle between the two directions is greater than 90°. Preferably, it has better effect in the case of 180°.

Preferably, the intensity of the reverse wind field is greater than that of the positive wind field, so that the direction of the accelerating wind field zone is the same as that of the reverse wind field. At this point, the realized accelerating wind field zone increases the relative velocity of the liquid drops and the air to a greater extent, doubling the atomization effect. In other cases, the intensity of the reverse wind field can be equal to or smaller than that of the positive wind field. At this point, although the accelerating wind field zone does not realize the reversion in the direction, the positive wind field is still weakened, the relative velocity of the liquid drops and the air is increased, and the atomization effect is still ideal.

An included angle between the axis of the air hole 23 and the radius of the centrifugal atomization disc 1 passing through the projection line center of an air hole wall of the axial section thereof is 60-75° on the axial section of the air hole perpendicular to the axis of the centrifugal atomization disc 1. The liquid drops thrown out from the centrifugal atomization disc has a certain angle relative to the tangential direction thereof, the direction of the air hole is designed in such a way that the gas ejected from the air hole and the direction of the liquid drop are 180° opposite to each other, the liquid drop cutting effect is better realized, and the atomization effect is better.

The air guide groove is communicated with an air outlet of an air pump, and the air guide groove is filled with air through the air pump. The hole diameter of the air outlet of the air hole may be 1-3 mm. If the hole diameter is too large, the gas pressure intensity is too small, so that the wind velocity of the reverse wind field is too small, and the purpose of improving the relative velocity of liquid drops cannot be achieved. The quantity ratio of the air holes to the flow guide grooves is 1:1 to 2:1, and too small quantity of the air holes will cause the wind velocity of the wind field zone to be relatively reduced, and the purpose of improving the relative velocity of liquid drops cannot be achieved.

The space 3 between the annular body 2 and the centrifugal atomization disc 1 in the radial direction thereof is 1-20 mm, preferably 5-15 mm; If the space 3 is too small, an accelerating wind field zone cannot be generated; and if the space 3 is too large, the accelerating wind field zone cannot improve the relative velocity of the liquid drops.

The diameter of the centrifugal atomization disc 1 is 50-300 mm. The flow guide groove 11 is Archimedes curve-shaped so as to improve the velocity of liquid drops thrown from the centrifugal atomization disc and improve the centrifugal atomization effect. The rotation velocity of the centrifugal atomization disc 1 is 2000-50000 rpm, preferably 10000-50000 rpm.

In the working state, the centrifugal atomization disc 1 rotates to throw liquid drops out of the flow guide groove 11, the air holes 23 in the annular body 2 inject air towards the centrifugal atomization disc 1 along the axial direction of the air holes 23, and the air flow generated by the injection air enables a reverse wind field to be generated between the annular body 2 and the centrifugal atomization disc 1, so that the positive wind field of the centrifugal atomization disc 1 is weakened or reversed. Therefore, an accelerating wind field zone is provided between the centrifugal atomization disc 1 and the annular body 2, and the accelerating wind field zone improves the relative velocity of liquid drops and air. Meanwhile, the direction of the high-pressure air flow generated in the air holes 23 is opposite to the direction of the liquid drops thrown out of the flow guide grooves 11, so that the liquid drops are further torn, and the atomization effect is better. When the flow velocity of the high-pressure air flow is increased, the wind field direction of the accelerating wind field zone can be directly controlled to realize the accelerating wind field zone which is weakened or opposite to the positive wind field, and the relative velocity of the liquid drops is flexibly increased. At this point, the size of liquid drops can be greatly reduced without increasing the rotation velocity of centrifugal atomization disc 1, which is simple, convenient and easy to achieve.

As shown in FIG. 9, the embodiment of the present disclosure further provides a centrifugal atomization device arranged on a spraying device (handheld spraying equipment or spraying unmanned aerial vehicle and the like) (not shown) and comprising a centrifugal atomization disc 1, wherein a plurality of flow guide grooves 11 are formed in the centrifugal atomization disc 1, and each flow guide groove 11 extends from the central position to the edge of the centrifugal atomization disc 1.

An annular body 2 is arranged at the outer side of the centrifugal atomization disc 1, the centrifugal atomization disc 1 is rotationally arranged relative to the main body of the spraying apparatus, and the annular body 2 is also rotationally arranged relative to the main body of the spraying apparatus; the centrifugal atomization disc 1 and the annular body 2 are respectively driven to rotate by corresponding motors, the annular body 2 and the centrifugal atomization disc 1 are arranged coaxially and may reversely rotate relative to each other, and the annular body 2 and the centrifugal atomization disc 1 are provided with a space 3 in the radial direction; the centrifugal atomization disc 1 rotates to form a positive wind field around the centrifugal atomization disc 1, and the positive wind field rotates clockwise or counterclockwise around the center of the centrifugal atomization disc 1; in the working state, the annular body 2 provides a reverse wind field between the annular body 2 and the centrifugal atomization disc 1, and the rotation direction of the reverse wind field is opposite to the rotation direction of the positive wind field; the reverse wind field and the positive wind field interact with each other to form an accelerating wind field zone, a plurality of teeth 21 are arranged on the annular body 2 at intervals along the circumferential direction of the annular body 2, and the teeth 21 are radially arranged outwards on the basis of the center of the annular body 2; when the annular body 2 rotates, one side, close to the centrifugal atomization disc 1, of the teeth 21 drives air nearby the centrifugal atomization disc 1 to flow so as to generate an air flow zone; and a plurality of air flow zones form a reverse wind field, and the reverse wind field weakens or reverses the positive wind field of the centrifugal atomization disc 1, so that the relative velocity of the liquid drops relative to the air can be improved to enhance the atomization effect. The direction of the air flow zone is opposite to that of the liquid drops thrown out of the centrifugal atomization disc 1, so that the liquid drops can be cut more effectively, and the atomization effect is further improved.

The teeth 21 are spaced and uniformly distributed in the circumferential direction of the annular body 2. The radial section of the tooth 21 is rectangular or arc-shaped; when the radial section of the tooth 21 is rectangular, the included angle between the radius of the centrifugal atomization disc 1 passing through a middle point of a long side of the rectangle and the long side is 0-60°; and when the radial section of the tooth 21 is arc-shaped, the included angle between the radius of the centrifugal atomization disc 1 passing through the middle point of the arc shape and a tangent line passing through the middle point of the arc shape is 0-60°.

After passing through the action of the air flow zone, the liquid drops impact on the teeth 21 and are emitted from the adjacent teeth, so that the liquid drops after the impact are smaller and more uniform in particle diameter to have better atomization effect. The included angle of the teeth 21 is designed, so that the impact effect can be better. Further, a 45° optimal incident angle impact can be realized to have better atomization effect.

The circumferential distance between two adjacent teeth 21 is greater than 2 mm, preferably greater than 3 mm, more preferably greater than 4 mm, to prevent surface tension on the teeth 21 from generating a liquid film and thereby causing the droplets to accumulate on the surfaces of teeth 21.

The tooth 21 has a dimension of 2-4 mm in the radial direction, a dimension of greater than 3 mm in the axial direction, and a dimension of 0.5-1 mm perpendicular to the radial direction. If the dimension of the tooth 21 in the radiation direction of the tooth 21 is too short, the teeth 21 are designed to be too dense to cause adhesion; and if the dimension of the tooth 21 in the radiation direction thereof is too long, a liquid film is formed on the surface of the tooth 21 when a plurality of liquid drops simultaneously hit one tooth 21, so that a next liquid drop is absorbed by the liquid film, and impact atomization cannot be realized. When the radial section of the tooth 21 is arc-shaped, the chord length corresponding to the arc is the dimension of the tooth in the radial direction thereof.

The annular body 2 and the teeth 21 are coated with an electroplated polytetrafluoroethylene layer or a nano layer, so that the annular body 2 and the teeth 21 have a non-sticking effect to prevent liquid drop accumulation and improve the atomization effect.

The quantity ratio of the teeth 21 to the flow guide grooves 11 is 0.5:1 to 2:1, preferably 1:1 to 1.8:1.

The space 3 between the annular body 2 and the centrifugal atomization disc 1 in the radial direction thereof is 1-20 mm, preferably 3-10 mm. If the space 3 is too small, an accelerating wind field zone cannot be generated; and if the space 3 is too large, the accelerating wind field zone cannot improve the relative velocity of liquid drops, and meanwhile, the effect of further impact cannot be achieved.

The diameter of the centrifugal atomization disc 1 is 50-300 mm. The flow guide groove 11 has an Archimedes curve shape. The rotation velocity of the centrifugal atomization disc 1 is 2000-50000 rpm, preferably 10000-50000 rpm, and the rotation velocity of the annular body 2 is 2000-50000 rpm, preferably 10000-50000 rpm. By increasing the rotation velocity of the annular body 2, a change in the direction of the accelerating wind band can be achieved. With the increase of the rotation velocity of the annular body 2, the accelerating wind field zone can be changed from the same rotation direction as the positive wind field to the rotation direction opposite to the positive wind field. That is, the rotation velocity of the annular body 2 can be directly and flexibly controlled, the relative velocity of the liquid drops relative to the air is increased, and therefore the atomization particle size of the liquid drops is reduced. In the embodiment, as long as the rotation velocity of the annular body 2 is selected, the atomization particle size of the liquid drops can be controlled, and the method is simple and convenient; the rotation velocity of the centrifugal atomization disc does not need to be increased, shattering caused by the fact that the rotation velocity of the centrifugal atomization disc is too high is avoided, and the method is easy to realize.

In the working state, the relative velocity of the liquid drops relative to the air is improved and the atomization effect is enhanced after the liquid drops are thrown out of the centrifugal atomization disc and subject to the action of an accelerating wind field zone. Meanwhile, the liquid drops impact on the teeth 21, so that accurate impact and further atomization are realized, the uniformity of atomized particles is improved, and the average particle diameter of the liquid drops is reduced, achieving the atomization effect of the average particle diameter of 30 micrometers, and even the atomization effect of the average particle diameter of 10 micrometers or below. In a specific embodiment, the rotation velocity of the centrifugal atomization disc 1 may be 25000 rpm, the rotation velocity of the annular body 2 may be 18000 rpm, the diameter of the centrifugal atomization disc 1 may be 100 mm, and the space 3 may be 7 mm. At this time, the atomization effect that the average particle diameter of liquid drops is less than 10 micrometers can be achieved, and the spraying effect is remarkably improved, which is difficult to achieve in the prior art.

For a brief description, reference is made to the above-described embodiments if there is anything not mentioned in this embodiment.

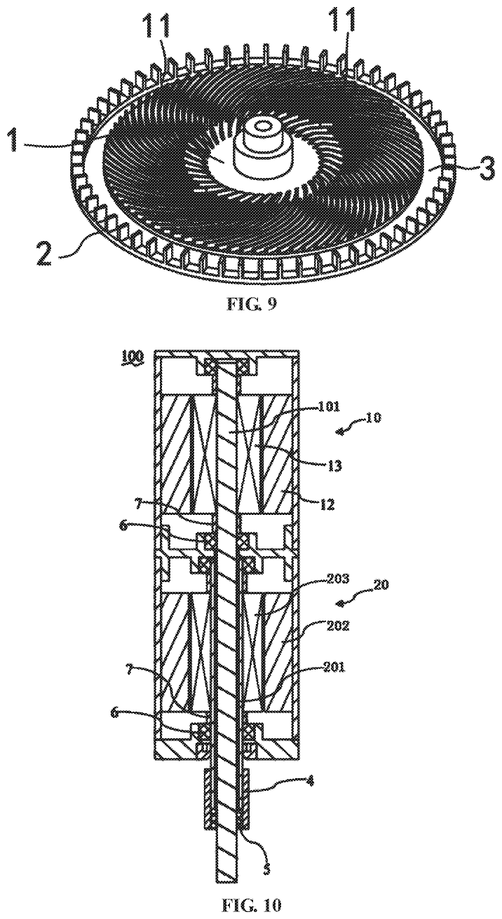

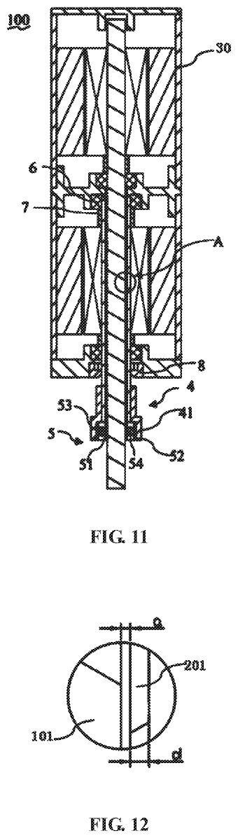

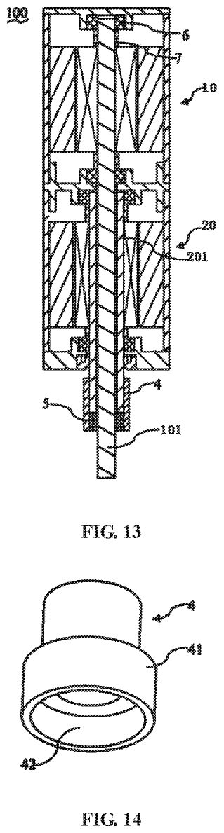

Even more preferably, referring to FIGS. 10 to 14, the drive device provided in this embodiment belongs to the spraying apparatus described in the above embodiment, and the technical solution described in the above embodiment also belongs to this embodiment. In order to solve at least one of the problems of unstable structure and small moment of inertia of a drive device in the prior art, the present disclosure provides a drive device 100, which is shown in FIGS. 10, 11 and 13 and comprises a first drive motor 10 including a first output shaft 101 extending out of the body of the first drive motor by a preset length, and a second drive motor 20 including comprising a hollow second output shaft 201, wherein the first drive motor 10 is arranged coaxially and in series with the second drive motor 20, and the first output shaft 101 penetrates through the second output shaft 201 and extends out of the second output shaft. By the series arrangement of the two drive motors, and the first output shaft 101 sleeved in the second output shaft 201, the diameters of the first output shaft 101 and the second output shaft 201 are thus reduced, the moment of inertia is reduced, and the rotation velocity of the drive device is increased. Therefore, the spraying device with high rotation velocity is realized.

It should be noted that the line direction defining the center of the cross-sectional circle of the drive device 100 is the axial direction, and the diameter direction defining the cross-sectional circle of the drive device 100 is the radial direction. Here, the first drive motor 10 is arranged coaxially and in series with the second drive motor 20. That is, the first drive motor 10 is coaxially superposed on the second drive motor 20 in the axial direction, whereby the second output shaft 201 in the axial direction passes through the first output shaft 101 in the axial direction. This design minimizes the diameters of the first output shaft 101 and the second output shaft 201 as far as possible. The smaller the diameters are, the smaller the moments of inertia of the drive motors are, and the more stably the drive motors rotate at high velocity. The preset length of the first output shaft 101 is greater than the length of the second drive motor and varies depending on factors such as the length of the second drive motor 20 and the rotary disc to be clamped, and is not limited thereto.

The drive device 100 further comprises a connecting piece 4 and a holder 5 coaxially arranged at a tail end of the second output shaft 201, wherein one end of the connecting piece 4 is sleeved on and fixed with the second output shaft 201, and the other end of the connecting piece 4 is filled with the holder 5 sleeved on the first output shaft 101 so as to support and stabilize the first output shaft 101 and the second output shaft 201. It is to be noted that the tail end of the second output shaft 201 is an end from which the first output shaft 101 protrudes. Specifically, as shown in FIG. 10, the connecting piece 4 has a hollow cylindrical shape, and the tail end of the second output shaft 201 is fixedly connected by being deeper into one end of the connecting piece 4. Preferably, the connecting means is an interference connection, i.e. a maximum outer diameter of the tail end of the second output shaft 201 is larger than a maximum inner diameter of the tail end of the connecting piece with which it is fitted. The connecting piece 4 is tightly sleeved on the second output shaft 201 by external force, the structure is simple, and the assembly is convenient. Of course, the connecting mode of the second output shaft 201 and the connecting piece 4 is not limited to this, but also can be bolted, riveted and other connections. The connecting piece 4 and the holder 5 are arranged at one end, extending out of the first output shaft 101, of the second output shaft 201, so that the two output shafts can be supported at the longest distance, preventing the phenomenon that the tail end structure is unstable due to the fact that the length of the first output shaft 101 or the second output shaft 201 is too long, and mutual contact or friction is caused to influence rotation; and the stability of the output shafts of the two drive motors is guaranteed to the greatest extent, and the rotating effect is improved.

Optionally, the drive device 100 further includes a housing 30 sleeved outside the first drive motor 10 and the second drive motor 20 to fix the first drive motor 10 and the second drive motor 20. The first drive motor 10 and the second drive motor 20 are simultaneously arranged in one housing 30, so that the structure is reasonable, the device is stable, and the installation is convenient.

According to the embodiment disclosed by the disclosure, the first output shaft and the second output shaft are arranged in series, the first output shaft is sleeved in the second output shaft, the moment of inertia is reduced, and the rotation velocity is increased to realize the high rotation velocity of 20000 rpm or higher; the two drive motors are arranged in series in the same housing 30, so that the positional relationship between the two output shafts is stable to avoid friction; and by the matching of the connecting piece and the holder, the position between the two output shafts is more stable, and the influence of friction on rotation is reduced.

For a brief description, reference is made to the above-described embodiments if there is anything not mentioned in this embodiment.

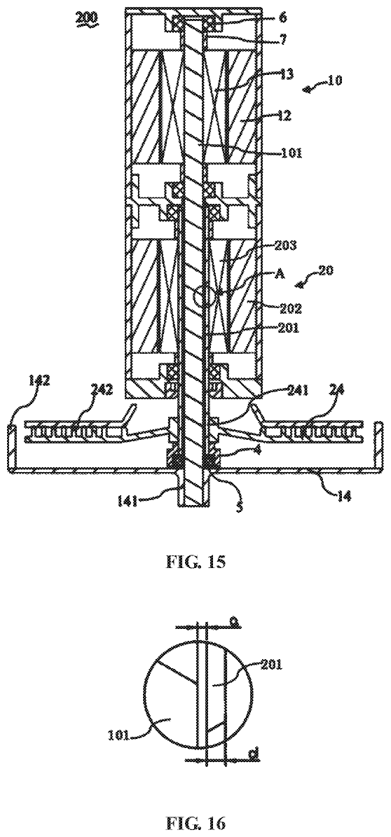

Even more preferably, referring to FIG. 10 and FIGS. 15, 16, 17, 18 and 19, the dual-drive spraying device provided in this embodiment belongs to the spraying apparatus described in the above embodiment, and the technical solution described in the above embodiment also belongs to this embodiment. Moreover, the dual-drive spraying device provided by this embodiment comprises the drive device provided by the above embodiment.

In order to solve at least one of the problems of large moment of inertia and unstable structure of the dual-drive spraying device in the prior art, the present disclosure provides a dual-drive spraying device 200, and as shown in FIGS. 10, 16 and 17, the dual-drive spraying device 200 comprises the drive device provided in the above embodiment, and a first rotary disc 14 sleeved on and fixedly connected with the first output shaft 101; and a second rotary disc 24 sleeved on and fixedly connected with the second output shaft 201. Alternatively, the first rotary disc 14 is provided at a central position thereof with a first positioning hole 141 through which the first output shaft 101 passes, the shape of the first positioning hole 141 being complementary to the shape of the cross section of the first output shaft 101 such that the first output shaft 101 passes through the first positioning hole 141 and is firmly fixed thereto, where the fixing method is not limited and may be performed by bolting, fastening or the like. Preferably, the maximum outer diameter of the first output shaft is larger than the hole diameter of the first positioning hole, so that the first output shaft is in interference fit and fixed with the first positioning hole, with a simple structure and easy installment. Alternatively, the second rotary disc 24 is provided at a central position thereof with a second positioning hole 241 through which the second output shaft 201 passes, the shape of the second positioning hole 241 being complementary to the shape of the cross section of the second output shaft 201, so that the second output shaft 201 passes through the second positioning hole 241 and is firmly fixed thereto, where the fixing method is not limited and may be connected by bolts, fasteners or the like. Preferably, the maximum outer diameter of the second output shaft is larger than the hole diameter of the second positioning hole, so that the second output shaft is in interference fit and fixed with the second positioning hole, with a simple structure and easy installment.

The dual-drive spraying device 200 further comprises a connecting piece 4 and a holder 5 coaxially arranged at the tail end of the second output shaft 201, wherein one end of the connecting piece 4 is sleeved on and fixed with the second output shaft 201, and the other end of the connecting piece 4 is filled with the holder 5 sleeved on the first output shaft 101 so as to support and stabilize the first output shaft 101 and the second output shaft 201. It should be noted that the tail end of the second output shaft 201 is an end from which the first output shaft 101 protrudes. As shown in detail in FIG. 15, the connecting piece 4 is provided between the second rotary disc 24 and the first rotary disc 14 and fixed to the tail end of the second output shaft 201, and the holder 5 is sleeved on the first output shaft 101 and filled inside the connecting piece 4 to support the first output shaft 101 and the second output shaft 201 and prevent the both from colliding and rubbing against each other. According to the dual-drive spraying device 200, the two drive motors are coaxially and concentrically arranged, two motors can be arranged on the same side to drive the two rotary discs to rotate; meanwhile, the rotary inertia can be reduced by matching the effects of the connecting piece and the holder, so that the two drive motors are more stable in structure, and safer and effective in rotation to realize more stable and efficient spraying operation.

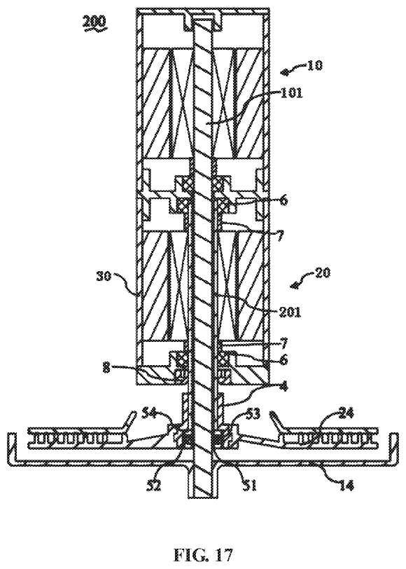

Alternatively, the second rotary disc 24 is sleeved on the connecting piece 4 and fixedly connected with the second output shaft 201. As shown in FIG. 17, the second positioning hole 241 is fixedly connected with the second output shaft 201 by the connecting piece 4. The difference from the embodiment of FIG. 15 is that the connecting piece 4 is arranged between the second output shaft 201 and the second rotary disc 24, and the second rotary disc 24 is fixedly connected with the connecting piece 4 by the second positioning hole 241 complementarily matched with the cross section shape of the connecting piece 4; as the connecting piece 4 is fixedly connected with the second output shaft 201, namely the second output shaft 201, the connecting piece 4 and the second rotary disc 24 are fixedly connected, so that the installation space of the connecting piece 4 is greatly saved to avoid an excessive distance between the first rotary disc 14 and the second rotary disc 24. Here, the connection method is not limited and may be a bolted connection, an interference connection, an injection-molded connection, etc.

Optionally, the connecting piece 4 comprises a hollow raised mating portion 41, the mating portion 41 forms a filling cavity 42 to fill the holder 5, and the second rotary disc 24 is sleeved on the mating portion 41. Herein, the second positioning hole 241 is connected and fixed with the mating portion 41 at one end of the connecting piece 4, without the need to be fixed with the whole connecting piece 4, so that the structural design of the second rotary disc 24 is reduced; meanwhile, the holder 5 can be filled skillfully, and the installation space of the connecting piece 4 and the holder 5 is further saved.

Preferably, a flange 43 is arranged on the mating portion 41 along the circumferential direction, so that the contact area with the second rotary disc 24 can be increased, the fixing and anti-slip effect is better, the strength of the fixed connection between the second rotary disc 24 and the connecting piece 4 is increased, and the safety and the stability are improved.

Optionally, the first rotary disc 14 is sleeved at a tail end of the first output shaft 101, and the second rotary disc 24 has an axial space from the first rotary disc 14 in the axial direction. It should be noted that the tail end of the first output shaft 101 is a lowermost end at which the dual-drive spraying device 200 is vertically disposed, and is also an end of the dual-drive spraying device 200 closest to a work object. In the axial direction, the axial space between the second rotary disc 24 and the first rotary disc 14 ensures that the two rotary discs do not touch each other to affect the rotating and spraying effects. The axial space is not limited, and a person skilled in the art would be able to design it according to requirements. Specifically, the first output shaft 101, the second output shaft 201, the first positioning hole 141 and the second positioning hole 241 are coaxially designed; the first output shaft 101 extends out of a certain length from one end of the second output shaft 201; and the rotation of the first output shaft 101 and the second output shaft 201 respectively drives the first rotary disc 14 and the second rotary disc 24 to coaxially move on different horizontal planes without interference, and high rotation velocity can be achieved. The extension length is not limited here, and is related to the axial space between the second rotary disc 24 and the first rotary disc 14. A person skilled in the art would also be able to design according to the size of the rotary disc and the influence factors of the atomization effect, as long as it is ensured that the first rotary disc 14 connected to the first output shaft 101 and the second rotary disc 24 connected to the second output shaft 201 do not interfere with each other and do not influence the atomization effect.

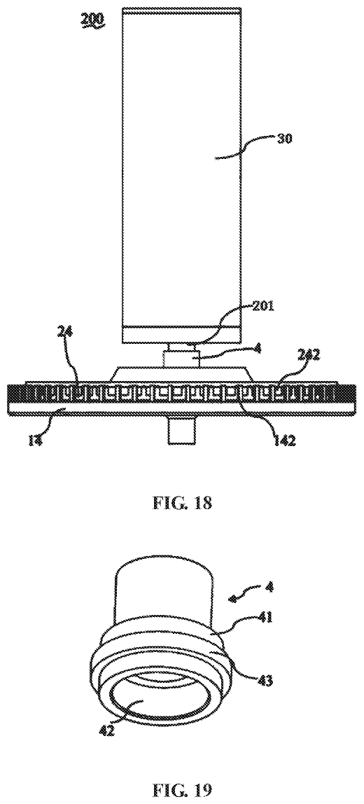

The spraying method specifically comprises the following steps. Referring to FIG. 18, a plurality of centrifugal flow channels 242 are provided on the second rotary disc 24, the second rotary disc 24 rotating at a high velocity is driven by the second output shaft 201 to perform centrifugal action on and atomize the incoming chemical liquid to form tiny droplets, and a cover plate is further provided on the second rotary disc 24 to prevent the droplets from splashing. A water inlet is arranged on the cover plate, so that liquid can enter the second rotary disc 24 from the water inlet. Of course, in some cases, the cover plate can be not arranged, and the liquid can be directly input onto the second rotary disc 24. The first rotary disc 14 and the second rotary disc 24 are arranged coaxially, one radial side of the first rotary disc 14 is circumferentially provided with a plurality of teeth 142 having a radial space from an axial side of the second rotary disc 24. With the design in this way, the first rotary disc 14 extends outside the second rotary disc 24, and the teeth of the first rotary disc 14 extend outside the second rotary disc 2. In the assembled state, the teeth 142 extend from the axial side of the second rotary disc 24, and the height of the upper end surface of the teeth 142 is greater than or equal to the horizontal height of the second rotary disc 24, so that droplets thrown out of the second rotary disc 24 are subjected to full-scale secondary atomization, ensuring that the droplets are subjected to secondary atomization as many droplets as possible. In one embodiment, it is also possible to arrange that the height of the upper end surface of the teeth 142 is smaller than the horizontal height of the second rotary disc 24, in which case a wind power device is arranged above the second rotary disc 24; under the action of the wind power device, the droplets have a downward trend, and the full-scale secondary atomization can be achieved without increasing the height of the teeth 142. Under the driving of the first output shaft 101, the teeth 142 rotating at a high velocity collide the droplets to achieve the purpose of secondary atomization, the particle diameter of the droplets can be reduced, the uniformity of the droplets can be improved, and the effect of forming droplets below 30 micrometers can be achieved. The radial space is related to, but not limited to, the rotation velocity of the first rotary disc 14, the rotation velocity of the second rotary disc 24, the size of the teeth, the density of the teeth, the reached particle size of the droplets, and the like. At the same time, considering the relationship between the height of the teeth 142 and the horizontal height of the second rotary disc 24, when the first rotary disc 14 and the second rotary disc 24 are designed, the axial space thereof cannot be too large, otherwise the structure of the teeth 142 is too high to affect the rotation velocity.

Alternatively, as shown in FIG. 16, the holder 5 includes an inner ring 51 fixedly connected with the first output shaft 101, an outer ring 52 fixedly connected with the connecting piece 4, and a rolling body 53 arranged between the inner ring 51 and the outer ring 52 to form rolling friction. Specifically, the holder 5 includes an inner ring 51 which rotates with the rotation of the first output shaft 101, an outer ring 52 which rotates with the rotation of the second output shaft 201, a rolling body 53, and a retainer 54; the inner ring 51 and the outer ring 52 form rolling friction by a plurality of rolling bodies 53, and the retainer 54 keeps a plurality of rolling bodies uniformly distributed in the inner ring 51 and the outer ring 52, so that the holder 5 and the connecting piece 4 cooperate to support the first output shaft 101 and the second output shaft 201, lower the friction coefficient and reduce the resistance, preventing the two output shafts from contacting to generate friction. It should be noted that the structure of the holder 5 shown in FIG. 10 is the same as that in FIGS. 15 and 17, and only the specific structure is omitted here.

It is to be noted that the first output shaft 101 passes out of the second output shaft 201 and then passes through the holder 5, and the connecting piece 4 is sleeved on the second output shaft 201 and the holder 5 at the same time and is fixedly connected with the both; the second rotary disc 24 is sleeved outside the connecting piece 5 and is fixedly connected with the connecting piece 5, and the connecting piece 5, the second rotary disc 24 and the outer ring on the holder 5 are driven to rotate at the same rotation velocity and direction when the second output shaft 201 rotates. The first output shaft 101 passing out of the holder 5 is sequentially sleeved with the inner ring of the holder 5 and the first rotary disc 11 from top to bottom, and the first rotary disc 11 and the inner ring of the holder 5 are driven to rotate at the same rotation velocity and direction when the first output shaft 101 rotates. The holder 5 serves to support and stabilize, preventing friction between the first output shaft 101 and the second output shaft 201.

Preferably, the connecting piece 4 comprises a hollow raised mating portion 41, as shown in FIGS. 15, 16 and 18, which forms a filling cavity 42 to fill the holder 5. Specifically, the connecting piece 4 has a hollow stepped cylindrical shape, one end of which is provided with a mating portion 41 having a hollow diameter larger than that of the other end, and the mating portion 41 and the holder 5 are fitted to receive the holder 5, so that the mating portion 41 can more easily receive the holder 5. It is convenient to assemble and also convenient to check whether it is properly installed; and at the same time, it is also avoided to increase the radial width of the side wall of the second output shaft 201 or reduce the maximum outer diameter of the holder 5, both of which are inadvisable. The holder 5 has a certain size. If the size is too small, the supporting effect cannot be achieved. The mating portion 41 is provided so that the radial width of the side wall of the second output shaft 201 can be prevented from being increased to fit and receive the holder 5. It is prevented that the rotational inertia is also increased due to the larger radial width of the second output shaft 201, and the high-velocity rotation cannot be achieved. The design of the mating portion 41 not only facilitates the assembly of the holder 5, but also prevents the diameter of the second output shaft 201 from being too large to increase the moment of inertia; and the mating portion 41 is arranged between the second output shaft 201 and the second rotary disc 24, so that the structural design of the second rotary disc 24 can be reduced, and the integral installation space of the connecting piece 4 and the holder 5 is saved, serving multiple purposes.

For the dual-drive spraying device 200, alternatively, the diameter of the first output shaft 101 is ≤8 mm, the hollow diameter of the second output shaft 201 is ≤12 mm, and the radial width d of the side wall of the second output shaft 201 is ≤5 mm. the radial width of the side wall is the thickness of the side wall in the radial direction of the second output shaft 201. Further, the first output shaft 101 and the second output shaft 201 may be designed to be smaller. For example, the diameter of the first output shaft 101 may be 5 mm, the hollow diameter of the second output shaft 201 may be 6 mm, the radial width d of the side wall may be 1 mm, or the diameter of the first output shaft 101 may be 4 mm, the hollow diameter of the second output shaft 201 may be 5 mm, and the side radial width d may be 2 mm or the like. A person skilled in the art would be able to design the dimensions of the first output shaft 101 and the second output shaft 201 according to structural requirements, without limiting the size thereof. Preferably, the smaller the diameter of the first output shaft 101, the hollow diameter of the second output shaft 201, and the radial width d of the side wall are designed, the smaller the moment of inertia is, and the more likely the high-velocity rotation can be achieved.

Optionally, the first output shaft 101 and the second output shaft 201 cooperate to have a radial clearance a ≥0.1 mm and/or ≤1 mm. The first output shaft 101 is cylindrical, the second output shaft 201 has a hollow cylindrical shape, and the two fit through each other. In one case, in order to prevent the first output shaft 101 from being in contact with the second output shaft 201 to generate friction and affect the output of the motor, causing that a high rotation velocity cannot be achieved, the radial clearance a cannot be too small, and is required to be ≥0.1 mm; and in the other case, the radial clearance a cannot be too large, preventing that the first output shaft 101 and the second output shaft 201 are too large in clearance to cause the diameter of the second output shaft 201 too large and increase the moment of inertia, which cannot be realize the high-velocity rotation. Thus, the radial clearance a is ≤1 mm. The radial clearance a may satisfy both ≥0.1 mm and ≤1 mm, or may satisfy either of ≥0.1 mm or ≤1 mm alone, without limitation.

Optionally, the first drive motor 10 comprises a first rotor 13 arranged on an inner race to drive the first output shaft 101 to rotate and a first stator 12 arranged on an outer race, and the second drive motor 20 comprises a second rotor 23 arranged on an inner race to drive the second output shaft 201 to rotate and a second stator 202 arranged on an outer race; and the first stator 12 and the second stator 202 are fixedly connected with a housing 30 sleeved outside the first drive motor 10 and the second drive motor 20, respectively. Specifically, the housing 30 is sleeved outside the first drive motor 10 and the second drive motor 20, and the first drive motor 10 and the second drive motor 20 are fixed with the housing 30 by the first stator 12 and the second stator 202. The structure is reasonable, the device is stable, and the installation is convenient. Here, the connection manner of the first stator 12 and the second stator 202 to the housing 30, respectively, is not limited, and may include an interference connection, a screw connection, a snap connection, an adhesive connection, etc., as long as the firmness of the connection of the first drive motor 10 and the second drive motor 20 to the housing 30, respectively, can be ensured. The first rotor 13 drives the first output shaft 101 to rotate, the second rotor 203 drives the second output shaft 201 to rotate, and the first stator 12 and the second stator 202 are respectively fixed with the housing 30, so that the positional relationship between the first output shaft 101 and the second output shaft 201 can be ensured without arranging redundant stabilizing parts between the two drive motors, and the first output shaft 101 and the second output shaft 201 are prevented from being influenced by contact friction. It should be noted that the first drive motor 10 and the second drive motor 20 may be brush motors or brushless motors.

Preferably, a bearing 6 is respectively sleeved at both ends of the second output shaft 201 penetrating through the second drive motor, and a bearing 6 is also sleeved at one end of the first output shaft 101 close to the second drive motor. Referring to FIG. 17, a bearing 6 is sleeved on the first output shaft 101, and two bearings are sleeved on the second output shaft 201, thereby functioning to support and stabilize the first output shaft 101 and the second output shaft 201. The three bearings 6, which cooperate with the connecting piece 4 and the holder 5 arranged at the tail end of the second output shaft 201, allow the first output shaft 101 and the second output shaft 201 to stably operate without colliding and rubbing with each other. Regardless of the length of the first output shaft 101, it will not cause rotational instability and affect rotational control. In another embodiment, as shown in FIGS. 10 and 15, it is also possible to sleeve the bearing 6 at an end of the first output shaft 101 remote from the second drive motor, so that the bearings 6 are provided at both sides of the first rotor 13, thereby ensuring the stability of the first output shaft. Of course, the cost and weight are increased by adding one bearing.

Preferably, a shaft sleeve 7 is provided between the bearing 6 and the first rotor 13 and between the bearing 6 and the second rotor 203, respectively, to prevent the first rotor 13 and the second rotor 203 from moving up and down during rotation and affecting the rotation.

Optionally, an end cover is arranged at one end, close to the connecting piece 4, of the second drive motor 20, a seal 8 is arranged at the central position of the end cover, and the seal 8 is sleeved on the second output shaft 201, so that the purposes of dust and water prevention are achieved. The end cap is sealingly connected with the housing 30, so that the first drive motor 10 and the second drive motor 20 are housed therein.

The following illustrates the operation process of the dual-drive spraying device 200. The second drive motor 20 drives the second output shaft 201 to rotate clockwise so as to drive the second rotary disc 24 to also rotate clockwise, the first drive motor 10 drives the first output shaft 21 to rotate anticlockwise so as to drive the first rotary disc 14 to rotate anticlockwise, and the rotation velocity can reach 20000 rpm or higher. The chemical liquid is injected into the second rotary disc 24, the second rotary disc 24 is provided with a plurality of centrifugal flow channels 242, the chemical liquid is torn under the action of the centrifugal flow channels 242 rotating at a high velocity to form tiny droplets. Meanwhile, the first rotary disc 14 is provided with a plurality of teeth 142, the teeth 142 rotating at a high velocity play a role of secondary atomization on the droplets, so that the particles of the droplets are smaller and more uniform to achieve the atomization effect of 30 micrometers or below. It should be noted that the rotational directions of the first output shaft and the second output shaft are not limited, and may be the same direction or opposite directions; the first drive motor and the second drive motor can rotate clockwise or counterclockwise, and a person skilled in the art could control the rotation directions of the first drive motor and the second drive motor as required.

According to the disclosure, the first output shaft and the second output shaft are arranged in series, the first output shaft is sleeved in the second output shaft, the moment of inertia is reduced, and the rotation velocity is increased to realize the high rotation velocity of 20000 rpm or higher; the two drive motors are arranged in series in the same housing 30, so that the positional relationship between the two output shafts is stable to avoid friction; and by the matching of the connecting piece and the holder, the position between the two output shafts is more stable, and the influence of friction on rotation is reduced. The connecting piece and the holder are arranged between the second output shaft and the second rotary disc, so that the installation space of the connecting piece and the holder is greatly saved, with simple structure and convenient installation, and also the connection firmness of the second output shaft and the second rotary disc is guaranteed.

The above-described embodiments are merely illustrative of the present disclosure and are not intended to be limiting of the present disclosure. Various changes and modifications may be made by one of ordinary skill in the pertinent art without departing from the scope of the present disclosure. Therefore, all equivalent technical solutions are intended to be within the scope of the present disclosure.

### INDUSTRIAL APPLICABILITY

According to the centrifugal atomization structure provided by the embodiment of the disclosure, the uniformity of atomized particles can be improved. By the impact, the atomization is more sufficient, the atomized particles are more uniform; and watering and spraying is more uniform for easier penetration, and the use amount of the chemical liquid is effectively saved.

It is to be understood that the foregoing is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “e.g.,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

1. A centrifugal atomization structure, comprising a centrifugal atomization disc, the centrifugal atomization disc is provided with a plurality of flow guide grooves, and each flow guide groove extends from the central position to the edge of the centrifugal atomization disc, wherein:
an annular body is arranged on the outer side of the centrifugal atomization disc, a plurality of teeth are arranged on the annular body at intervals along the circumferential direction of the annular body, and the teeth are radially arranged outwards on the basis of the center of the annular body; and
the annular body and the centrifugal atomization disc are coaxially arranged, and a space is arranged between the annular body and the centrifugal atomization disc in the radial direction thereof.

2. The centrifugal atomization structure according to claim 1, wherein the annular body is externally coated with an electroplated polytetrafluoroethylene layer or a nano layer.

3. The centrifugal atomization structure according to claim 1, wherein the centrifugal atomization disc is rotationally arranged, the annular body is relatively fixed, or the annular body and the centrifugal atomization disc are oppositely arranged in a rotation direction.

4. (canceled)

5. A centrifugal atomization device, comprising a centrifugal atomization disc, the centrifugal atomization disc is provided with a plurality of flow guide grooves, and each flow guide groove extends from the central position to the edge of the centrifugal atomization disc, wherein:
an annular body is arranged at the outer side of the centrifugal atomization disc, the annular body and the centrifugal atomization disc are arranged coaxially and are able to be rotated relative to each other, and a space is arranged between the annular body and the centrifugal atomization disc in the radial direction; and the centrifugal atomization disc rotates to form a positive wind field around the centrifugal atomization disc, and the positive wind field rotates clockwise or counterclockwise around the center of the centrifugal atomization disc;
in the working state, the annular body provides a reverse wind field between the annular body and the centrifugal atomization disc, and the rotation direction of the reverse wind field is opposite to that of the positive wind field;
the reverse wind field and the positive wind field interact to form an accelerating wind field zone between the centrifugal atomization disc and the annular body; and
a plurality of air flow zones are formed on the annular body, the air flow zones are distributed at intervals in the circumferential direction of the annular body, the air flow zones are arranged corresponding to liquid drops thrown out of the flow guide groove, and the air flow direction of the air flow zones is opposite to a running direction of the liquid drops thrown out of the flow guide groove.

6. The centrifugal atomization device according to claim 5, wherein the intensity of the reverse wind field is greater than that of the positive wind field, so that the direction of the accelerating wind field zone is the same as that of the reverse wind field.

7. The centrifugal atomization device according to claim 5, wherein the annular body is fixedly arranged relative to the centrifugal atomization disc, a circle of air guide grooves are formed in the annular body along the circumferential direction of the annular body, a plurality of air holes are formed in the inner circumferential surface of the annular body, the air holes are communicated with the air guide grooves and distributed at intervals in the circumferential direction of the annular body, and the air flow zone is led out of the air guide grooves along the extending direction of the air holes.

8. The centrifugal atomization device according to claim 7, wherein an included angle between the axis of the air hole and the radius of the centrifugal atomization disc passing through the projection line center of a hole wall of the axial section is 60°-75° on an axial section of the air hole perpendicular to the axis of the centrifugal atomization disc.

9. The centrifugal atomization device according to claim 7, wherein the quantity ratio of the air holes to the flow guide grooves is 1:1 to 2:1.

10. The centrifugal atomization device according to claim 5, wherein the annular body reversely rotates relative to the centrifugal atomization disc, a plurality of teeth are arranged on the annular body at intervals along the circumferential direction of the annular body, the teeth are radially arranged outwards on the basis of the center of the annular body, and the air flow zone is generated at one side, close to the centrifugal atomization disc, of the teeth.

11. The centrifugal atomization device according to claim 10, wherein the radial section of the tooth is rectangular or arc-shaped;
when the radial section of the tooth is rectangular, the included angle between the radius of the centrifugal atomization disc passing through a middle point of a long side of the rectangle and the long side is 0-60°;
when the radial section of the tooth is arc-shaped, the included angle between the radius of the centrifugal atomization disc passing through the middle point of the arc shape and a tangent line passing through the middle point of the arc shape is 0-60°.

12. The centrifugal atomization device according to claim 10, wherein the tooth has a dimension of 2-4 mm in the radial direction, a dimension of greater than 3 mm in the axial direction of the centrifugal atomization disc, and a dimension of 0.5-1 mm perpendicular to the radial direction.

13. (canceled)

14. (canceled)

15. (canceled)

16. (canceled)

17. A dual-drive spraying device, comprising:
a first drive motor including a first output shaft extending out of the body of the first drive motor by a preset length;
a second drive motor arranged coaxially and in series with the first drive motor and comprising a hollow second output shaft, wherein the first output shaft penetrates through the second output shaft and extends out of the second output shaft;
a first rotary disc sleeved on and fixedly connected with the first output shaft, wherein the first rotary disc is provided with a plurality of centrifugal flow channels;
a second rotary disc sleeved on and fixedly connected with the second output shaft;
a connecting piece and a holder coaxially arranged at a tail end of the second output shaft, wherein one end of the connecting piece is sleeved on and fixed with the second output shaft, and the other end of the connecting piece is filled with a holder sleeved on the first output shaft
wherein the first rotary disc and the second rotary disc are coaxially arranged; and
wherein a radial side of the first rotary disc is circumferentially provided with a plurality of teeth having a radial space from an outer edge of the second rotary disc in a radial direction.

18. The dual-drive spraying device according to claim 17, wherein the connecting piece comprises a hollow raised mating portion, the mating portion forms a fill cavity to fill the holder, and the second rotary disc is sleeved on the mating portion.

19. The dual-drive spraying device according to claim 18, wherein the mating portion is circumferentially provided with a flange.

20. (canceled)

21. The dual-drive spraying device according to claim 17, wherein the holder comprises an inner ring fixedly connected with the first output shaft, an outer ring fixedly connected with the connecting piece, and a rolling body arranged between the inner ring and the outer ring to generate rolling friction.

22. The dual-drive spraying device according to claim 17, wherein the first and second output shafts cooperate to have a radial clearance, the clearance being ≥0.1 mm and/or ≤1 mm.

23. The dual-drive spraying device according to claim 17, wherein the first drive motor comprises a first rotor arranged on an inner race to drive the first output shaft to rotate and a first stator arranged on an outer race, and the second drive motor comprises a second rotor arranged on an inner race to drive the second output shaft to rotate and a second stator arranged on an outer race, and the first stator and the second stator are respectively fixedly connected with a housing sleeved outside the first drive motor and the second drive motor.
